(19) United States
(12) Patent Application Publication
(10) Pub. No.: US 2007/0118521 A1
(43) Pub. Date: May 24, 2007

(54) Page reranking system and page reranking program to improve search result

(76) Inventors: Adam Jatowt, Kyoto (JP); Yukiko Kawai, Tokyo (JP); Katsumi Tanaka, Tokyo (JP)

Correspondence Address: Snell & Wilmer L.L.P., Suite 1400, 600 Anton Boulevard, Costa Mesa, CA, 92626, US

(21) Appl. No.: 11/601,260

(22) Filed: Nov. 17, 2006

(30) Foreign Application Priority Data
Nov. 18, 2005 (JP) P2005-334657

(51) Int. Cl. G06F 17/30

(52) U.S. Cl. 707/5

(57) ABSTRACT

A page reranking system is a system that grants renewed page rankings to multiple Web pages that are obtained as search result pages in compliance with a user's query and to which page rankings are granted by calculating a change rate of a page content between multiple versions of each of the Web pages, and comprises a reranking device that grants the renewed page ranking to each of the Web pages based on the change rate of the page content between multiple versions calculated for each of the Web pages.

### FIELD OF THE ART

This invention relates to a page reranking system and a page reranking program for granting a renewed page ranking to a Web page that can be obtained as a search engine result page and to which a page ranking is given.

### BACKGROUND ART

A search engine service has been known that rapidly extracts and outputs a correct search engine result from flood of information on the Web in compliance with a query. In order to make it possible to utilize the search engine result more effectively, a technology has been proposed that gives a page ranking as being an evaluation index showing its usability to a Web page obtained as a search engine result page.

More concretely, an outline of a technology that grants this kind of a page ranking will be explained.

For example, a link from a Web page A to a Web page B is considered to be a supporting vote to the Web page B by the Web page A and importance of the Web page B is judged based on a number of the supporting votes. At this time, not only the number of the supporting votes, namely a number of links to the Web page but also the Web page that casts the supporting vote is analyzed. Then the supporting vote cast by the Web page whose “level of importance” is high is more highly evaluated and the Web page that receives the supporting vote is set to be “an important page”. It is so arranged that the important page that receives the high evaluation by this link analysis is given a high page ranking and its ranking in the search engine results becomes high. (refer to non-patent documents 1 through 3).

Non-Patent Document 1

“Google no ninnki no himitsu (Secret of Google's popularity)”
http://www.google.co.jp/intl/ja/why_use.html
   Non-Patent Document 2
“Google searches more sites more quickly, delivering the most relevant results”
http://www.google.com/technology/index.html
   Non-Patent Document 3
   “Benefits of Google Search”
http://www.google.com/technology/whyuse.html

### DISCLOSURE OF THE INVENTION

### Problems to be Solved by the Invention

However, in accordance with a conventional technique, a page ranking of a Web page becomes high on a condition that a number of links to the Web page is large even though the Web page is not updated. For example, even though the Web page is updated in order to enrich the page content, the page ranking does not rapidly reflect a fact that the Web page is updated. In other words, even though a Web page is updated so as to contain a fresh and important content, a fact that newness or a degree of importance is increased is not reflected on the page ranking, unless the Web page is a portal site which a lot of people visit and a lot of links are provided.

The present claimed invention germinates from an idea completely different from a view point of the conventional technology. The idea is to make a role of the page ranking substantial by introducing an evaluation index whose view point is that the importance is placed on a fact the Web page is updated, and by making the page ranking take into account a level of importance of the page content. More specifically, an object of the present claimed invention is to provide a superior page reranking system that can grant a page ranking of a high utility value based on the updated page content and a change rate of the page content updated in compliance with the user's query.

### SUMMARY OF THE INVENTION

More specifically, a page reranking system in accordance with this invention is a system that grants renewed page rankings to multiple Web pages that are obtained as search result pages in compliance with a user's query and to which page rankings are granted by calculating a change rate of a page content between multiple versions of each of the Web pages updated in compliance with the user's query, and is characterized by comprising a reranking device that grants the renewed page ranking to each of the Web pages based on the change rate of the page content between the multiple versions calculated for each of the Web pages.

“The Page ranking” here is an evaluation index showing usability of the Web page, and is utilized, for example, for displaying multiple Web pages obtained related to a search term included in the query in a descending order of “evaluation” in case of displaying its URL on a search result page. More specifically, if this page ranking is used, it is possible to easily search a Web page that corresponds to the query and that is accurate.

In accordance with this arrangement, for example, in case that a change rate of a page content updated in compliance with a user's query between versions of a certain Web page is bigger than that of the other Web page, the reranking device newly grants a page ranking upper than that of the other Web page to the relevant Web page. Then it is possible for a user to know that the page content is updated and importance of the Web page becomes high based on the renewed page ranking.

More specifically, it is possible to provide the superior page reranking system that can grant a page ranking of a high utility value based on the updated page content and the change rate of the page content updated in compliance with the user's query.

In order to improve an accuracy of reranking or to change its processing speed, it is preferable that the reranking device comprises either one of or both of a first reranking processing device that refers to a Web archive device memorizing the Web pages that existed on the Internet in the past and that conducts a reranking process to each of the Web pages based on the change rate of the page content between the multiple versions of each of the Web pages updated in compliance with the user's query and a second reranking processing device that conducts a reranking process to each of the Web pages based on the change rate of the page content updated in compliance with the user's query between an indexed page version of each Web page cached as the search result page and a present page version of each Web page existing on the Internet, and the reranking processing is conducted to each of the Web pages by the use of either one of or both of the first reranking processing device and the second reranking processing device.

As a preferable mode of the first reranking processing device of this invention, it is represented that the first reranking processing device comprises a change rate calculating device that calculates the change rate of the page content between the multiple versions of each of the Web pages updated in compliance with the user's query, a first permutation ranking determining device that determines a permutation ranking in order to permutate the multiple Web pages in an ascending order or a descending order based on the change rate of the page content calculated by the change rate calculating device, and a first ranking granting device that grants a renewed page ranking corresponding to the permutation ranking determined by the first permutation ranking determining device to each of the Web pages.

If the change rate calculating device calculates a temporal quality of the page content between the multiple versions of each of the Web pages as the change rate of the page content, the temporal quality showing its change can be utilized for reranking pages as the change rate even though the page content is changed by addition or deletion, which makes it possible to conduct very useful reranking.

It is preferable to use the following equation to calculate the temporal quality TQ of the page.

$$\begin{matrix}( Equation 1 ) & \\ \begin{matrix}T Q = \frac{1}{{\sum }_{j = 1}^{j = n - 1} \frac{1}{( {T}^{present} - {T}_{j} )}} * \\ {\sum }_{j = 1}^{j = n - 1} \{ \frac{1}{( {T}^{present} - {T}_{j}^{past} )} * \frac{cos ( {A}_{( j , j + 1 )}^{c} , Q )}{( {T}_{j + 1} - {T}_{j} )} * ( 1 + \frac{{S}_{( j , j + 1 )}^{c}}{{S}_{j}} ) \}\end{matrix} & ( 1 )\end{matrix}$$

Here, n is the number of past page versions, A^{c}_{(j,j+1)} is the vector of added changes between the j and j+1 versions of the page, cos (A^{c}_{(j,j+1)}, Q) is the cosine similarity between vector A^{c}_{(j,j+1)} and query vector Q, S^{c}_{(j,j+1)} is the size of the added change between the j and j+1 versions of the page, Sⱼ is the total size (total number of words) of the j version expressed as the number of words, Tⱼ and Tⱼ₊₁ are the timestamps of the consecutive past versions of the page, T^{present} is the time when the query is issued, and Tⱼ^{past} is equal to Tⱼ.

If the first ranking granting device is so arranged to grant a renewed page ranking to only the Web page whose ranking is upper than a predetermined order in the permutation ranking determined by the first permutation ranking determining device, it is possible to prevent calculation of renewed page ranking unnecessarily, thereby to reduce burden for this system.

If the Web archive device memorizes the Web page that existed on the Internet in the past and version administrating information such as year-month-day that can administrate the version of the Web page in a mutually associated manner, it is possible to obtain the content change of the Web page between versions quickly and accurately on the strength of the version administrating information.

If the first reranking processing device obtains a change of a page content between every consecutive pair of versions of the Web pages archived by the Web archive device in case of calculating the change rate of the page content, it is possible to conduct accurate reranking.

As a preferable mode of the second reranking processing device in accordance with this invention, it is represented that the second reranking processing device comprises a page ranking value calculating device that calculates a page ranking value in order to set a renewed page ranking based on the change rate of the page content updated in compliance with the user's query between the indexed page version and the present page version for each of the Web pages, a second permutation ranking determining device that determines a permutation ranking in order to permutate the multiple Web pages in an ascending order or a descending order based on the page ranking value calculated by the page ranking value calculating device, and a second ranking granting device that grants a renewed page ranking corresponding to the permutation ranking determined by the second permutation ranking determining device to each of the Web pages.

It is preferable to use the following equation to calculate the page ranking value R^{new}ᵢ.

$$\begin{matrix}( Equation 2 ) & \\ \begin{matrix}{R}_{i}^{new} = [ \frac{cos ( {A}_{i} , Q ) - α * cos ( {D}_{i} , Q ) + 1}{β * ( {T}^{present} - {T}_{i}^{indexed} ) + 1} ] * \\ [ 1 + γ * \frac{N - {R}_{i}^{se} + 1}{N} ] * [ 1 + η * ( \frac{{S}_{i}^{a}}{{S}_{i}^{indexed}} + μ * \frac{{S}_{i}^{d}}{{S}_{i}^{indexed}} ) ]\end{matrix} & ( 2 )\end{matrix}$$

cos (Aᵢ, Q) is the cosine similarity between the vector of additions Aᵢ for the page i and the query vector Q, cos (Dᵢ, Q) is the cosine similarity between the vector of deletions Dᵢ for the page i and the query vector Q, R^{se}ᵢ is the original ranking assigned to the page by a search engine, T^{indexed}ᵢ is the date when the search engine indexed the page, T^{present} is the present time when the query is issued, and S^{a}ᵢ, S^{d}ᵢ, S^{indexed}ᵢ denote the number of words in additions (the number of added words), deletions (the number of deleted words), and in the indexed version (total number of words) of the page, respectively. And α, β, γ, η, and μ are the weights used to adjust the effects of the features on the renewed ranking. Each of β, γ, and η can take a value of 0 through 1, and each of α and μ can take a value of −1 through 1. In addition, N is a total number of URLs as being an object to be reranked among a number of search result URLs obtained by the search engine.

If the second ranking granting device grants the renewed page ranking to only the Web page whose ranking is upper than a predetermined order in the permutation ranking determined by the second permutation ranking determining device, it is possible to prevent calculation of renewed page ranking unnecessarily, thereby to reduce burden for this system.

In order to attempt reduction of cost by making use of a general-purpose system, it is preferable that the search result page is obtained by a searching process by the use of a Web search engine.

As mentioned above, in accordance with the page reranking system of this invention, for example, in case that a change rate of a page content between versions of a certain Web page is bigger than that of the other Web page, the reranking device newly grants a page ranking upper than that of the other Web page to the relevant Web page. Then it is possible for a user to know that the page content is updated and importance of the Web page becomes high based on the renewed page ranking.

More specifically, it is possible to provide the superior page reranking system that can grant a page ranking of a high utility value based on the updated page content and the change rate of the page content updated in compliance with the user's query.

### BRIEF DESCRIPTION OF THE DRAWINGS

FIG. 1 is an overview showing a system using a page reranking system in accordance with one embodiment of the present claimed invention.

FIG. 2 is a configuration diagram of the page reranking system in accordance with this embodiment.

FIG. 3 is a configuration diagram of the page reranking system in accordance with this embodiment.

FIG. 4 is a view to explain a method for calculating added changes between versions in accordance with this embodiment.

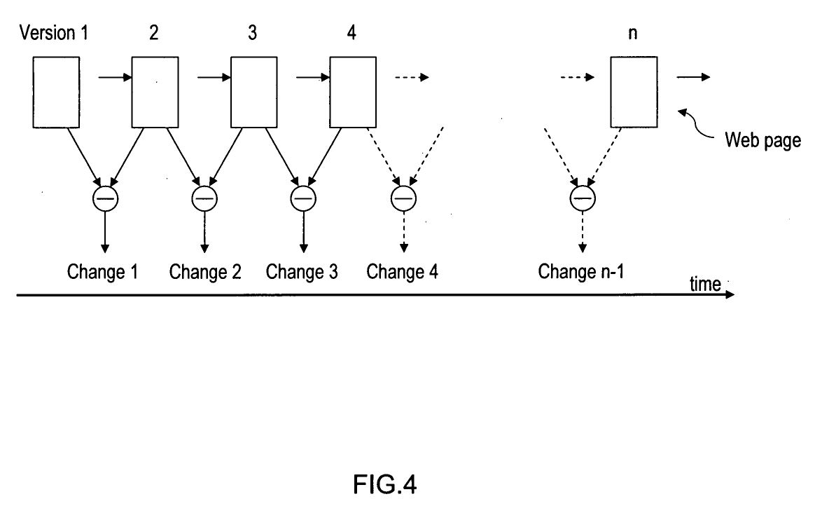

FIG. 5 is a flow chart showing a performance of the page reranking system in accordance with this embodiment.

FIG. 6 is a configuration diagram of a page reranking system in accordance with another embodiment of the present claimed invention.

FIG. 7 is a configuration diagram of a page reranking system in accordance with further different embodiment of the present claimed invention.

### DETAILED DESCRIPTION OF THE PREFERRED EMBODIMENTS

A page reranking system as being one embodiment of the present claimed invention will be explained with reference to drawings.

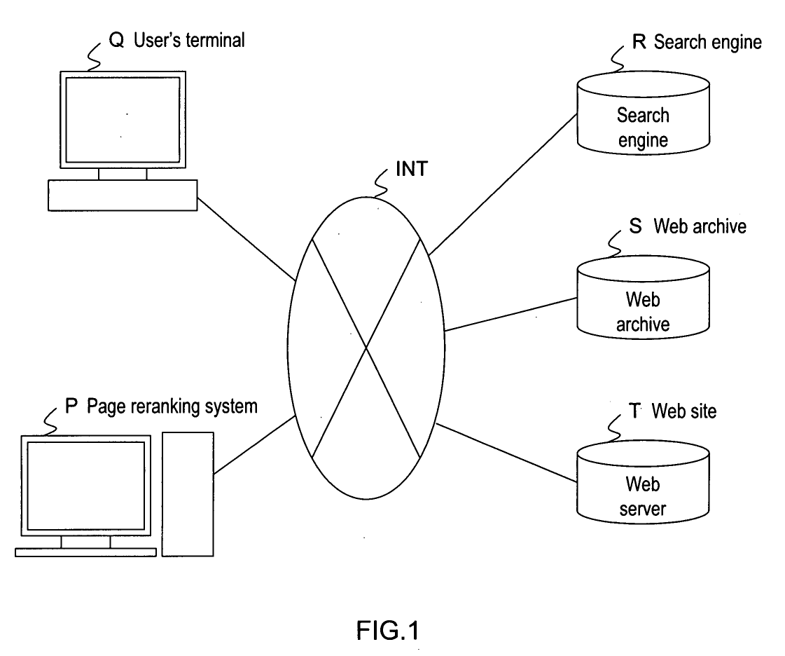

The page reranking system P in accordance with this embodiment is so arranged to grant renewed page rankings to multiple Web pages that are obtained as search result pages and to which page rankings are granted by calculating a change rate of a page content between multiple versions of each of the Web pages updated in compliance with a user's query, and as shown in FIG. 1, is connected in a mutually communicable manner to a user's terminal Q such as a personal computer provided at a user's side, a search engine R (corresponds to “a Web search engine” in this invention), a Web archive S (corresponds to “a Web archive device” in this invention), and a Web site T through a predetermined communication line net such as the Internet INT. In this embodiment, the page reranking system P and the user's terminal Q are separately arranged, however, they may be integrally formed. In addition, the same also applies to other devices. The search engine R is the Web site T where information open on the Internet INT can be searched by the use of a keyword and this embodiment uses a full text search type. The kind of the search engine R is not limited to this. In addition, the Web archive S is a Web site where the Web page that existed on the Internet INT in the past is memorized in association with version administrating information such as year-month-day that can administrate the version of the Web page, and this embodiment makes use of a Web site generally called as “an Internet archive”.

Next, the page reranking system P will be concretely explained.

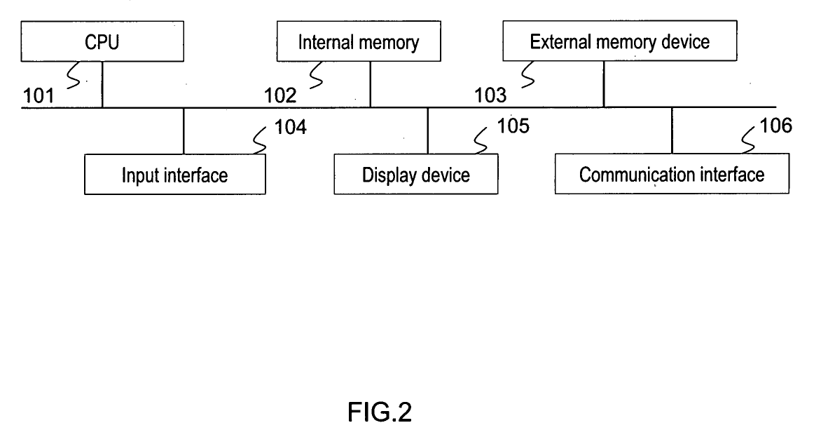

The page reranking system P is provided with a general information processing function, and as shown in FIG. 2, comprises a CPU 101, an internal memory 102, an external memory 103 such as an HDD, an input interface 104 such as a mouse or a keyboard, a-display device 105 such as a liquid-crystal display and a communication interface 106 to be connected with a communication line net such as an in-house LAN or the Internet.

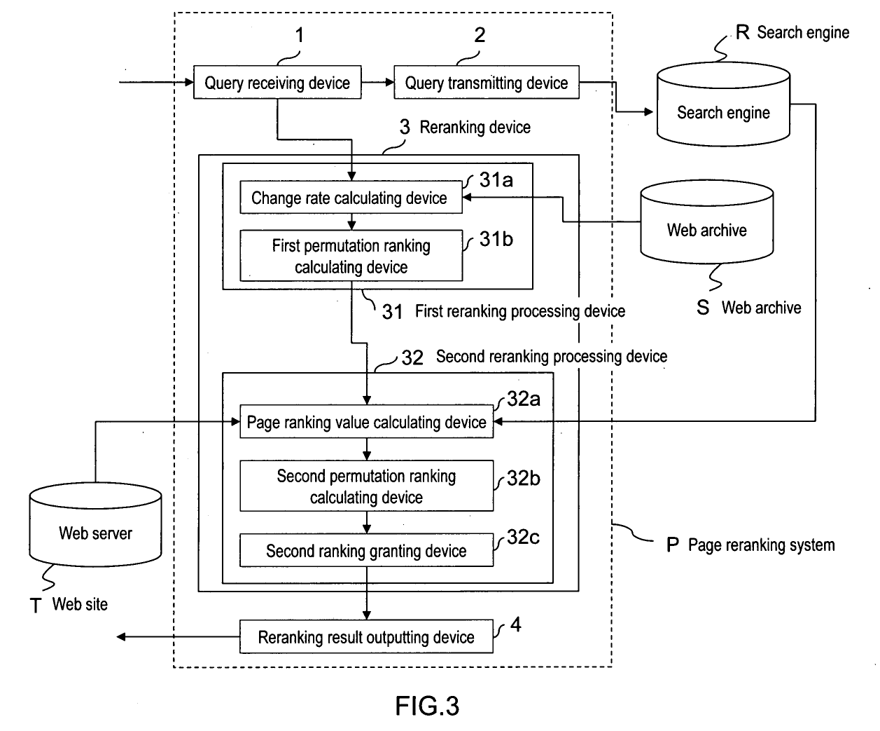

The page reranking system P operates the CPU 101 and its peripheral devices in accordance with a page reranking program memorized in the internal memory 102 and as shown in FIG. 3, produces functions as a query receiving device 1, a query transmitting device 2, a reranking device 3 comprising a first reranking processing device 31 and a second reranking processing device 32, and a reranking result outputting device 4. Each device will be explained as follows.

The query receiving device 1 receives a query transmitted from the user's terminal Q and makes use of the communication interface 106.

The query transmitting device 2 transmits the query received by the query receiving device 1 to the search engine R and makes use of the communication interface 106.

The reranking device 3 grants the renewed page ranking to each of the Web pages based on the change rate of the page content between the multiple versions calculated for each of the Web pages and comprises the first reranking processing device 31 and the second reranking processing device 32. Each of the first and second reranking processing devices 31, 32 will be explained more concretely.

The first reranking processing device 31 refers to the Web archive S memorizing the Web pages that existed on the Internet INT in the past and conducts a reranking process to each of the Web pages based on the change rate of the page content between the multiple versions of each of the Web pages updated in compliance with the user's query, and further comprises a change rate calculating device 31a and a first permutation ranking determining device 31b.

The change rate calculating device 31a calculates a temporal quality TQ of the page content between the multiple versions of each of the Web pages as the change rate of the page content.

In this embodiment the temporal quality TQ of the page is calculated by the following equation.

$$\begin{matrix}( Equation 1 ) & \\ \begin{matrix}T Q = \frac{1}{{\sum }_{j = 1}^{j = n - 1} \frac{1}{( {T}^{present} - {T}_{j} )}} * \\ {\sum }_{j = 1}^{j = n - 1} \{ \frac{1}{( {T}^{present} - {T}_{j}^{past} )} * \frac{cos ( {A}_{( j , j + 1 )}^{c} , Q )}{( {T}_{j + 1} - {T}_{j} )} * ( 1 + \frac{{S}_{( j , j + 1 )}^{c}}{{S}_{j}} ) \}\end{matrix} & ( 1 )\end{matrix}$$

Here, n is the number of past page versions, A^{c}_{(j,j+1)} is the vector of added changes between the j and j+1 versions of the page, cos (A^{c}_{(j,j+1)}, Q) is the cosine similarity between vector A^{c}_{(j,j+1)} and query vector Q, S^{c}_{(j,j+1)} is the size of the added change between the j and j+1 versions of the page, Sⱼ is the total size (total number of words) of the j version expressed as the number of words, Tⱼ and Tⱼ₊₁ are the timestamps of the consecutive past versions of the page T^{present} is the time when the query is issued, and Tⱼ^{past} is equal to Tⱼ.

In addition, in this embodiment the first reranking processing device 31 preliminarily calculates an added change of a page content (Change(1,2), . . . , Change(n−1,n)) between every consecutive pair of versions of the Web pages.

More concretely, the change of the page content between every consecutive pair of versions of the Web pages is obtained with the following method.

First, a text data is obtained for each Web page by removing an HTML tag or an image. A character string with which addition or deletion is provided is obtained by obtaining difference between the obtained two text data. A stop word is removed from the obtained character string and then a stemming process is conducted for the obtained character string after the stop word is removed. Here the stop word is a word that appears frequently in a document but is not useful for specifying a content of the document, and is represented by, for example, a definite article such as “a” or “the”, a conjunction such as “and”, a pronoun and a be verb. It is preferable that the stop word is preliminary placed on a list and the stop word is removed with reference to the list. In addition, the stemming process is a process to take out a stem of a word after removal of an ending of the word. This process makes it possible to prevent a case that an originally the same word is dealt as a different word if the word is dealt without considering a change of the word due to conjugation of an ending of the word. With this procedure, a change between versions (Change (1,2), . . . , Change(n−1,n)) can be obtained.

The first permutation ranking determining device 31b determines a permutation ranking in order to permutate the multiple Web pages in an ascending order or a descending order based on the change rate of the page content calculated by the change rate calculating device 31a. In this embodiment the multiple Web pages are permutated in a descending order of a value of the temporal quality TQ.

The second reranking processing device 32 conducts a reranking process to each of the Web pages based on the change rate of the page content between an indexed page version of each Web page cached in the search engine R as the search result page and a present page version of each Web page existing on the Web site T of the Internet INT updated in compliance with the user's query, and comprises a page ranking value calculating device 32a, a second permutation ranking determining device 32b and a second ranking granting device 32c. In this embodiment, the second reranking processing device 32 is so arranged to conduct a reranking process to Web page whose ranking is upper than a predetermined order in the permutation ranking determined by the first permutation ranking determining device 31b, however, the reranking process may be conducted to all Web pages.

The page ranking value calculating device 32a calculates a page ranking value in order to set a renewed page ranking based on the change rate of the page content updated in compliance with the user's query between the indexed page version and the present page version for each of the Web pages.

In this embodiment, the page ranking value is calculated by the following equation.

$$\begin{matrix}( Equation 2 ) & \\ \begin{matrix}{R}_{i}^{new} = [ \frac{cos ( {A}_{i} , Q ) - α * cos ( {D}_{i} , Q ) + 1}{β * ( {T}^{present} - {T}_{i}^{indexed} ) + 1} ] * \\ [ 1 + γ * \frac{N - {R}_{i}^{se} + 1}{N} ] * [ 1 + η * ( \frac{{S}_{i}^{a}}{{S}_{i}^{indexed}} + μ * \frac{{S}_{i}^{d}}{{S}_{i}^{indexed}} ) ]\end{matrix} & ( 2 )\end{matrix}$$

cos (Aᵢ, Q) is the cosine similarity between the vector of additions Aᵢ for the page i and the query vector Q. cos (Dᵢ, Q) is the cosine similarity between the vector of deletions Dᵢ for the page i and the query vector Q. R^{se}ᵢ is the original ranking assigned to the page by a search engine. T^{indexed}ᵢ is the date when the search engine indexed the page. T^{present} is the present time when the query is issued, and S^{a}ᵢ, S^{d}ᵢ, S^{indexed}ᵢ denote the number of words in additions (the number of added words), deletions (the number of deleted words), and in the indexed version (total number of words) of the page, respectively. And α, β, γ, η, and μ are the weights used to adjust the effects of the features on the renewed ranking. Each of β, γ, and η can take a value of 0 through 1, and each of α and μ can take a value of −1 through 1. In addition, N is a total number of URLs as being an object to be reranked among a number of search result URLs obtained by the search engine.

The second permutation ranking determining device 32b determines a permutation ranking in order to permutate the multiple Web pages in an ascending order or a descending order based on the page ranking value calculated by the page ranking value calculating device 32a. In this embodiment the multiple Web pages are permutated in a descending order of the page ranking value.

The second ranking granting device 32c grants the renewed page ranking corresponding to the permutation ranking determined by the second permutation ranking determining device 32b to each of the Web pages.

The second ranking granting device 32c may be arranged to grant a renewed page ranking only to the Web page whose ranking is upper than a predetermined order in the permutation ranking determined by the second permutation ranking determining device 32b.

The reranking result outputting device 4 outputs to transmit a renewed page ranking granted by the second ranking granting device 32c to the user's terminal Q and makes use of the communication interface 106. The renewed page ranking is output to be transmitted as a URL list of the Web page, but an output mode of the renewed page ranking may be varied arbitrarily in accordance with an embodiment.

Next, an operation of thus arranged page reranking system P will be explained with reference to a flow chart.

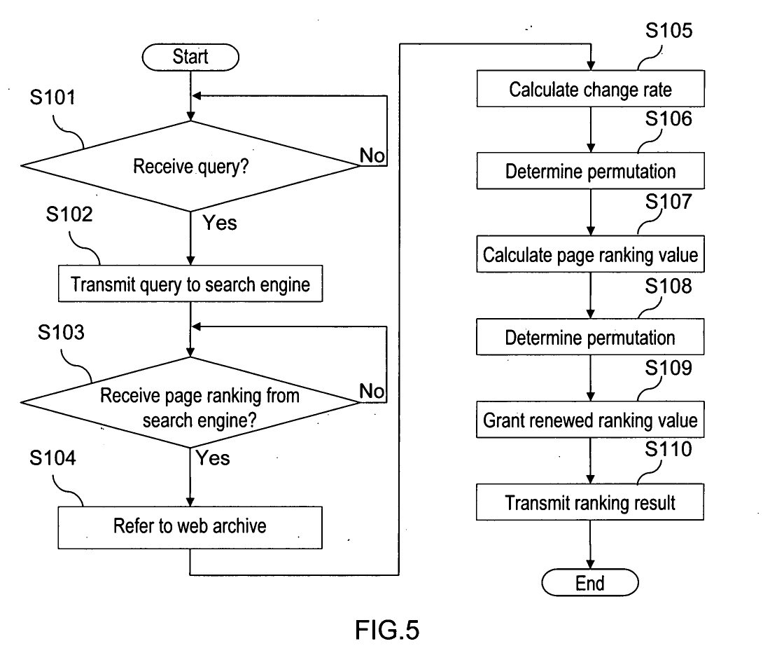

As shown in FIG. 5, first the query receiving device 1 receives a query transmitted from the user's terminal Q (step S101), and then the query transmitting device 2 transmits the query received by the query receiving device 1 to the search engine R (step S102).

Then when a page ranking is received from the search engine R (step S103), the change rate calculating device 31a of the first reranking processing device 31 refers to the Web archive S (step S104), and the temporal quality TQ of the page content between the multiple versions of each of the Web pages updated in compliance with the user's query is calculated as the change rate of the page content (step S105). The temporal quality TQ is calculated by the use of the expression (1) shown by (equation 5).

Next, the first permutation ranking determining device 31b determines a permutation of the multiple Web pages in a descending order of the value of the temporal quality TQ calculated by the change rate calculating device 31a (step S106).

Furthermore, the page ranking value calculating device 32a calculates a page ranking value in order to set a renewed page ranking based on the change rate of the page content updated. In compliance with the user's query between the indexed page version and the present page version for each of the Web pages (step S107). The page ranking value is calculated by the use of the expression (2) shown by (equation 6). Then the second permutation ranking determining device 32b determines the permutation based on this page ranking value (step S108), and the second ranking granting device 32c grants a corresponding renewed page ranking to each Web page (step S109).

Then the reranking result outputting device 4 outputs to transmit the renewed page ranking granted by the second ranking granting device 32c to the user's terminal Q (step S110).

As mentioned above, in accordance with the page reranking system P of this invention, for example, in case that a change rate of a page content between versions of a certain Web page is bigger than that of the other Web page, the reranking device 3 newly grants a page ranking upper than that of the other Web page to the relevant Web page. Then it is possible for a user to know that the page content is updated and importance of the Web page becomes high based on the renewed page ranking.

More specifically, it is possible to provide the superior page reranking system P that can grant a page ranking of a high utility value based on the updated page content and the change rate of the page content updated in compliance with the user's query.

Since the reranking device 3 comprises the first reranking processing device 31 that refers to the Web archive S memorizing the Web pages that existed on the Internet in the past and that conducts the reranking process to each of the Web pages based on the change rate of the page content between the multiple versions of each of the Web pages and the second reranking processing device 32 that conducts the reranking process to each of the Web pages based on the change rate of the page content between an indexed page version of each Web page cached in the search engine R as the search result page and the present page version of each Web page existing on the Internet, and the reranking process is conducted to each of the Web pages, it is possible to preferably improve the accuracy of reranking.

Since the change rate calculating device 31a calculates the temporal quality TQ of the page content between the multiple versions of each of the Web pages updated in compliance with the user's query as the change rate of, the page content, the temporal quality TQ showing its change can be utilized for reranking the pages as the change rate of the content even though the page content is changed by addition or deletion, thereby to conduct the reranking of a very high utility value.

Since the second reranking processing device 32 is so arranged to grant the renewed page ranking only to the Web page whose ranking is upper than a predetermined order in the permutation ranking determined by the first permutation ranking determining device 31b, it is possible to prevent calculation of renewed page ranking unnecessarily, thereby to reduce burden for this system.

Since this page reranking system P makes use of the Web archive S that memorizes the Web page that existed on the Internet in the past and the version administrating information such as year-month-day that can administrate the version of the Web page in a mutually associated manner, it is possible to obtain the change of the content of the Web page between versions quickly and accurately on the strength of the version administrating information.

Since the first reranking processing device 31 obtains the change of the page content between every consecutive pair of versions of the Web pages archived by the Web archive S in case of calculating the change rate of the page content, it is possible to conduct the accurate reranking.

The present claimed invention is not limited to the above-mentioned embodiment.

For example, in this embodiment the reranking device 3 comprising the first reranking processing device 31 and the second reranking processing device 32 is used, however, the reranking device 3 may comprise either one of the reranking processing devices 31, 32.

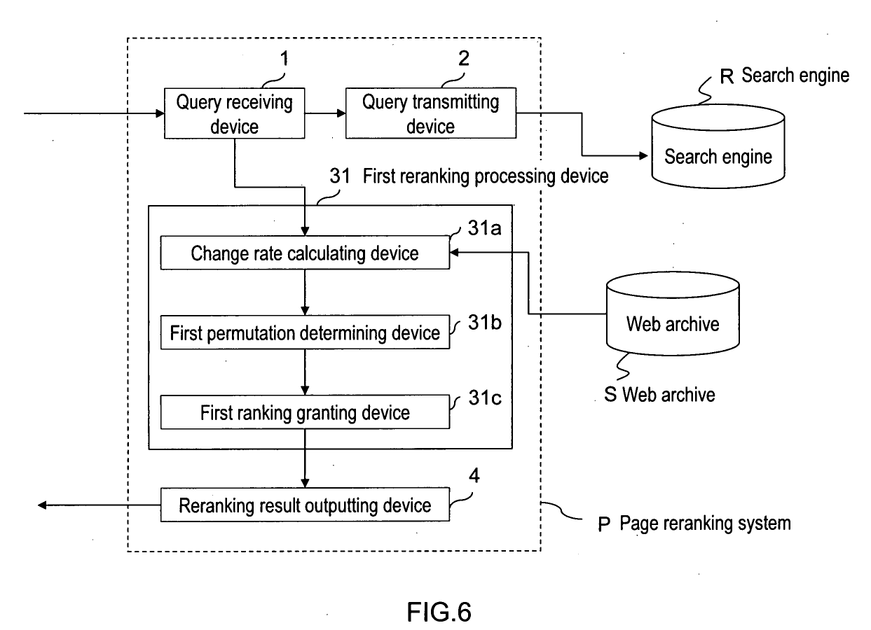

More concretely, in case of the reranking device 3 comprising the first reranking processing device 31 alone, the first reranking processing 31 comprises, as shown in FIG. 6, a change rate calculating device 31a, a first permutation ranking determining device 31b and a first ranking granting device 31c. The change rate calculating device 31a and the first permutation ranking determining device 31b have generally the same operation and effect as those of the above-mentioned embodiment, and the first ranking granting device 31c grants the renewed page ranking corresponding to a permutation ranking determined by the first permutation ranking determining device 31b to each of the above-mentioned Web pages.

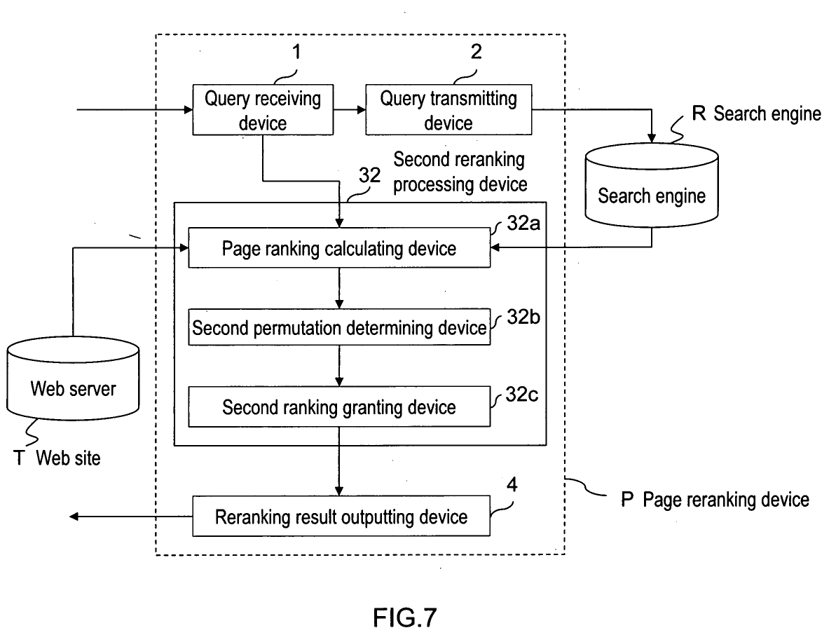

Meanwhile, in case of the reranking device 3 comprising the second reranking processing device 32 alone, the second reranking processing 32 comprises, as shown in FIG. 7, a page ranking value calculating device 32a, a second permutation ranking determining device 32b and a second ranking granting device 32c. The page ranking value calculating device 32a, the second permutation ranking determining device 32b and the second ranking granting device 32c have generally the same operation and effect as those of the above-mentioned embodiment.

The Web archive S makes use of a Web site generally called as “the Internet archive”, however, the used site is not limited to this.

In addition, the temporal quality TQ is calculated by the use of the Equation 1, however, it is not limited to this. The Equation 1 may also be expressed as follows.

$$\begin{matrix}T Q = \frac{1}{{\sum }_{j = 1}^{j = n - 1} \frac{1}{( {T}^{present} - {T}_{j} )}} * \\ {\sum }_{j = 1}^{j = n - 1} \{ \frac{1}{( {T}^{present} - {T}_{j} )} * \frac{sim ( {V}_{( j , j + 1 )}^{added} , Q )}{( {T}_{j + 1} - {T}_{j} )} * ( 1 + \frac{{S}_{( j , j + 1 )}^{added}}{{S}_{j}} ) \}\end{matrix} \qquad ( 3 )$$

Here, n is the number of past page versions, V^{added}_{(j,j+1)} is the vector of added changes between the j and j+1 versions of the page, sim (V^{added}_{(j,j+1)}, Q) is the similarity between vector V^{added}_{(j,j+1)} and query vector Q, S^{added}_{(j,j+1)} is the size of the added change between the j and j+1 versions of the page, Sⱼ is the total size (total number of words) of the j version expressed as the number of words, Tⱼ and Tⱼ₊₁ are the timestamps of the consecutive past versions of the page, and T^{present} is the time when the query is issued.

In addition, in this embodiment the first reranking processing device 31 preliminarily calculates an added change of a page content (Change(1,2), . . . , Change(n−1,n)) between every consecutive pair of versions of the Web pages and represents it as a sequence of added change vectors (V^{added}_{(1,2)}, . . . , V^{added}_{(n-1,n)}).

In addition, the page ranking value is calculated by the Equation 2, however, it is not limited to this. The Equation 2 may also be expressed as follows.

$$\begin{matrix}{R}_{i}^{new} = [ \frac{sim ( {A}_{i} , Q ) - α * sim ( {D}_{i} , Q ) + 1}{β * ( {T}^{present} - {T}_{i}^{indexed} ) + 1} ] * \\ [ 1 + γ * \frac{N - {R}_{i}^{se} + 1}{N} ] * [ 1 + η * ( \frac{{S}_{i}^{addition}}{{S}_{i}^{indexed}} + μ * \frac{{S}_{i}^{deletion}}{{S}_{i}^{indexed}} ) ]\end{matrix} \qquad ( 4 )$$

Here, sim (Aᵢ, Q) is the similarity between the vector of additions Aᵢ, for the page i and the query vector Q, sim (Dᵢ, Q) is the similarity between the vector of deletions Dᵢ for the page i and the query vector Q, R^{se}ᵢ is the original ranking assigned to the page by a search engine, T^{indexed}ᵢ is the date when the search engine indexed the page, T^{present} is the present time when the query is issued, and S^{addition}ᵢ, S^{deletion}ᵢ, S^{indexed}ᵢ denote the number of words in additions (the number of added words), deletions (the number of deleted words), and in the indexed version (total number of words) of the page, respectively. And α, β, γ, η, and λ are the weights used to adjust the effects of the features on the renewed ranking. Each of β, γ,and η can take a value of 0 through 1, and each of α and μ can take a value of −1 through 1. In addition, N is a total number of URLs as being an object to be reranked among a number of search result URLs obtained by the search engine.

The first processing device can be used simply for any web pages, thus, for the pages not necessarily obtained from search engine results. Such a mechanism may be called ranking.

A set of collaborating archives can be utilized at the same time for obtaining more past versions of pages. The output from these archives will be merged together in order to more precisely construct the hestry (past content) of web pages.

The present claimed invention is not limited to the above embodiment, and there may be variously modified without departing from a spirit of this invention.

1. A page reranking system that is a system that grants renewed page rankings to multiple Web pages that are obtained as search result pages in compliance with a user's query and to which page rankings are granted by calculating a change rate of a page content between multiple versions of each of the Web pages, wherein the page reranking system comprises a reranking device that grants the renewed page ranking to each of the Web pages based on the change rate of the page content between the multiple versions of each of the Web pages updated in compliance with the user's query and calculated for each of the Web pages.

2. The page reranking system described in claim 1, wherein the reranking device comprises either one of or both of a first reranking processing device that refers to a Web archive device memorizing the Web pages that existed on the Internet in the past and that conducts a reranking process to each of the Web pages based on the change rate of the page content between the multiple versions of each of the Web pages updated in compliance with the user's query and
a second reranking processing device that conducts a reranking process to each of the Web pages based on the change rate of the page content updated in compliance with the user's query between an indexed page version of each Web page cached as the search result page and a present page version of each Web page existing on the Internet, and
the reranking processing is conducted to each of the Web pages by the use of either one of or both of the first reranking processing device and the second reranking processing device.

3. The page reranking system described in claim 2, wherein the first reranking processing device comprises
a change rate calculating device that calculates the change rate of the page content between the multiple versions of each of the Web pages updated in compliance with the user's query,
a first permutation ranking determining device that determines a permutation ranking in order to permutate the multiple Web pages in an ascending order or a descending order based on the change rate of the page content calculated by the change rate calculating device, and
a first ranking granting device that grants a renewed page ranking corresponding to the permutation ranking determined by the first permutation ranking determining device to each of the Web pages.

4. The page reranking system described in claim 3, wherein the change rate calculating device calculates a temporal quality of the page content between the multiple versions for each of the Web pages as the change rate of the page content.

5. The page reranking system described in claim 4, wherein the temporal quality is calculated by the following equation,
$$\begin{matrix}( Equation 1 ) & \\ \begin{matrix}T Q = \frac{1}{{\sum }_{j = 1}^{j = n - 1} \frac{1}{( {T}^{present} - {T}_{j} )}} * \\ {\sum }_{j = 1}^{j = n - 1} \{ \frac{1}{( {T}^{present} - {T}_{j}^{past} )} * \frac{cos ( {A}_{( j , j + 1 )}^{c} , Q )}{( {T}_{j + 1} - {T}_{j} )} * ( 1 + \frac{{S}_{( j , j + 1 )}^{c}}{{S}_{j}} ) \}\end{matrix} & ( 1 )\end{matrix}$$
Here, n is the number of past page versions, A^{c}_{(j,j+1)} is the vector of added changes between the j and j+1 versions of the page, cos (A^{c}_{(j,j+1)}, Q) is the cosine similarity between vector A^{c}_{(j,j+1)} and query vector Q, S^{c}_{(j,j+1)} is the size of the added change between the j and j+1 versions of the page, Sⱼ is the total size (total number of words) of the j version expressed as the number of words, Tⱼ and Tⱼ₊₁ are the timestamps of the consecutive past versions of the page, T^{present} is the time when the query was issued, and Tⱼ^{past} is equal to Tⱼ.

6. The page reranking system described in claim 3, wherein the first ranking granting device grants the renewed page ranking to only the Web page whose ranking is upper than a predetermined order in the permutation ranking determined by the first permutation ranking determining device.

7. The page reranking system described in claim 2, wherein the Web archive device memorizes the Web page that existed on the Internet in the past and version administrating information such as year-month-day that can administrate the version of the Web page in a mutually associated manner.

8. The page reranking system described in claim 2, wherein the first reranking processing device obtains a change of the page content between every consecutive pair of versions of the Web pages archived by the Web archive device in case of calculating the change rate of the page content.

9. The page reranking system described in claim 2 , wherein the second reranking processing device comprises
a page ranking value calculating device that calculates a page ranking value in order to set a renewed page ranking based on the change rate of the page content updated in compliance with the user's query between the indexed page version and the present page version for each of the Web pages,
a second permutation ranking determining device that determines a permutation ranking in order to permutate the multiple Web pages in an ascending order or a descending order based on the page ranking value calculated by the page ranking value calculating device, and a second ranking granting device that grants a renewed page ranking corresponding to the permutation ranking determined by the second permutation ranking determining device to each of the Web pages.

10. The page reranking system described in claim 9, wherein the page ranking value is calculated by the following equation.
$$\begin{matrix}( Equation 2 ) & \\ \begin{matrix}{R}_{i}^{new} = [ \frac{cos ( {A}_{i} , Q ) - α * cos ( {D}_{i} , Q ) + 1}{β * ( {T}^{present} - {T}_{i}^{indexed} ) + 1} ] * \\ [ 1 + γ * \frac{N - {R}_{i}^{se} + 1}{N} ] * [ 1 + η * ( \frac{{S}_{i}^{a}}{{S}_{i}^{indexed}} + μ * \frac{{S}_{i}^{d}}{{S}_{i}^{indexed}} ) ]\end{matrix} & ( 2 )\end{matrix}$$
cos (Aᵢ, Q) is the cosine similarity between the vector of additions Aᵢ for the page i and the query vector Q, cos.(Dᵢ, Q) is the cosine similarity between the vector of deletions Dᵢ for the page i and the query vector Q, R^{se}ᵢ is the original ranking assigned to the page by a search engine, T^{indexed}ᵢ is the date when the search engine indexed the page, T^{present} is the present time when the query is issued, and S^{a}ᵢ, S^{d}ᵢ, S^{indexed}ᵢ denote the number of words in additions (the number of added words), deletions (the number of deleted words), and in the indexed version (total number of words) of the page, respectively. And α, β, γ, η, and λ are the weights used to adjust the effects of the features on the renewed ranking. In addition, N is a total number of URLs as being an object to be reranked among a number of search result URLs obtained by the search engine.

11. The page reranking system described in claim 9, wherein the second ranking granting device grants the renewed page ranking to only the Web page whose ranking is upper than a predetermined order in the permutation ranking determined by the second permutation ranking determining device.

12. The page reranking system described in claim 1, wherein the search result page is obtained by a searching process by the use of a Web search engine.

13. A page reranking program that is a program to operate a computer so as to grant renewed page rankings to multiple Web pages that are obtained as search result pages in compliance with a user's query and to which page rankings are granted by calculating a change rate of a page content between multiple versions of each of the Web pages,
and the page reranking program makes the computer function as a reranking device that grants the renewed page ranking to each of the Web pages based on the change rate of the page content between the multiple versions updated in compliance with the user's query calculated for each of the Web pages.

14. The page reranking program described in claim 13, wherein the reranking device comprises either one of or both of
a function as a first reranking device that refers to a Web archive device memorizing the Web pages that existed on the Internet in the past and that conducts a reranking process to each of the Web pages based on the change rate of the page content updated in compliance with the user's query between multiple versions, and
a function as a second reranking device that conducts a reranking process to each of the Web pages based on the change rate of the page content updated in compliance with the user's query between an indexed page version cached as the search result page and a present page version existing on the Internet,
and the reranking processing is conducted to each of the Web pages by the use of either one of or both of the first reranking processing device and the second reranking processing device.

15. The page reranking program described in claim 14, wherein the first reranking processing device comprises
a function as a change rate calculating device that calculates the change rate of the page content updated in compliance with the user's query between the multiple versions of each of the Web pages, a function as a first permutation ranking determining device that determines a permutation ranking in order to permutate the multiple Web pages in an ascending order or a descending order based on the change rate of the page content calculated by the change rate calculating device, and
a function as a first ranking granting device that grants a renewed page ranking corresponding to the permutation ranking determined by the first permutation ranking determining device to each of the Web pages.

16. The page reranking program described in claim 14, wherein the second reranking processing device comprises
a function as a page ranking value calculating device that calculates a page ranking value in order to set a renewed page ranking based on the change rate of the page content updated in compliance with the user's query between the indexed page version and the present page version for each of the Web pages,
a function as a second permutation ranking determining device that determines a permutation ranking in order to permutate the multiple Web pages in an ascending order or a descending order based on the page ranking value calculated by the page ranking value calculating device, and
a function as a second ranking granting device that grants a renewed page ranking corresponding to the permutation ranking determined by the second permutation ranking determining device to each of the Web pages.
